(19) United States
(12) Patent Application Publication
(10) Pub. No.: US 2008/0268913 A1
(43) Pub. Date: Oct. 30, 2008

(54) Method and Device for Wireless Sound Production Into User's Ear

(75) Inventor: Taito Heikkinen, Kajaani (FI)

Correspondence Address: YOUNG & THOMPSON, 209 Madison Street, Suite 500, ALEXANDRIA, VA, 22314, US

(73) Assignee: Wearfon OY, Kajaani (FI)

(21) Appl. No.: 12/092,418

(22) PCT Filed: Nov. 2, 2006
(86) PCT No.: PCT/FI2006/050475

§ 371 Date: Jun. 5, 2008

(30) Foreign Application Priority Data
Nov. 3, 2005 (FI) 20055590

(51) Int. Cl. H04M 1/00

(52) U.S. Cl. 455/569.1

(57) ABSTRACT

The invention relates to a method, by which a personal communication system is formed, and a device arrangement for forming sound wirelessly to the ear. The arrangement includes an earphone part (2), a telephone part (1) and a keyboard and display device (3), between which there is a low-power radio connection. The control electronics (23) of the earphone part include a power management system, which reduces the power consumption close to zero or to zero when there is no communication between the earphone part (2) and the telephone part (1). The earphone (2) has been shaped so small that it can be fitted at least partly into the user's ear or the canal of the ear. The earphone part also includes a rechargeable or non-rechargeable battery (21) and possibly a charging system (26), which can be implemented by solar cells, kinetic energy, sound energy, induction or a thermoelectric converter. The telephone part (1) consists of a display (11), keyboard (12), one or more microphones (13), a battery (14), a radio unit (15), electronic unit (17) and an antenna unit (18). The radio technique used can be, for example, the UWB technique, which has a high data transfer capacity with low power requirement.

The invention relates to a method, by which a personal communication system is formed, and a device/device arrangement for forming sound wirelessly to the ear. In particular, the invention relates to the implementation of handsfree operation in connection with mobile phones or the like. By the application of the invention, it is also possible to implement an earphone device, which can be held in place in the ear for a longer period of time.

A large number of various handsfree devices (later in the text a HF device), are generally known, and they either provide duplex radio communication or are connected to the mobile phone by a conductor. A HF device provided with a conductor is inconvenient in use, and the conductor continuously hanging from the user's ear is not very esthetic with regard to the user's appearance. The conductor gets easily tangled with various objects and may cause dangerous situations. For example, when driving a car, arranging a wired HF device into the ear and connecting it to other devices may be highly dangerous. The hanging conductor makes it more difficult to use the safety belt and can become tangled with the steering wheel or other driving control devices, whereby the driver's concentration on steering and other control of the vehicle is disturbed.

The connector of the HF device is generally small and mechanically weak, and therefore even a small mechanical stress may damage it and prevent the operation of the whole device. Devices based on Radio Frequency technology (RF), such as the HF products based on the Bluetooth technology, which are generally available on the market today, provide significantly more modern operation. They are characterized by a short operating time, because the Bluetooth technology consumes a lot of power during use. In the worst case, the battery runs down in the middle of a phone call, forcing the user to recharge the HF device and establish a new telephone connection. Depending on the degree of utilization, their operating time is normally from a few hours to a few days at the most.

A solution, in which information is transferred wirelessly between the earphone and the actual telephone part, is presented in the published application GB 2 239 120, Data transfer between the parts is duplex.

The Bluetooth HF devices are relatively large, because both the earphone and the microphone are integrated into the same device. The Bluetooth HF devices available on the market are generally fastened by a hook behind the ear, and the microphone in the front part of the HF device and the earphone part rest against the ear. One such solution is presented in the published application DE 100 05 007. Bluetooth HF devices cause difficulties when worn together with clothing accessories, because their large size makes them reach outside the earlobe. The weight of the device feels uncomfortable, and due to the inertial forces, the device can easily swing in the ear when the user moves his head. Other people in the vicinity may hear the sound from the earphone, because it is not tightly against the ear.

The HF products generally in use are mobile phone accessories. A loudspeaker is then also required in the phones, and it takes space from the actual telephone device and increases its size unnecessarily. In some phone models, the HF function has been implemented so that the loudspeaker of the phone reproduces the sound, and the microphone of the phone is used as the microphone. In that case, however, the privacy of the phone call suffers, because all the people in the vicinity can hear the voice of both parties of the phone call.

In the present phone devices, there is a large variety of different operations integrated in one device, in which case compromises have had to be made with regard to usability or properties. For example, it is more difficult to write messages with a small keypad than a large keyboard. The size of the phones, which is getting smaller and smaller: makes it more difficult to place high-quality camera optics etc. in the phone.

There are special phones on the market intended for the visually handicapped, in which the menus of the telephone part have been implemented by sound, and the control of which towards the telephone part takes place by voice or some other sound.

The objective of the method and equipment/device arrangement of the invention is to eliminate the above mentioned drawbacks and to create a personal communication system for the users of the device, in which, for example, sound is formed wirelessly to the user's ear.

The earphone part of the equipment/device arrangement according to the invention can be substantially smaller than the present ones, and hence it can be placed close to the canal of the ear. The HF device can also be placed partly or entirely in the user's ear or even inside the canal of the ear. The operating time or the earphone part may be several weeks or months, and it can be implemented in a small size. The radio communication between the earphone part and the telephone is mainly simplex. For example, for establishing the connection and during other handshaking between the devices, radio communication may be duplex, when required. By keeping the radio communication mainly simplex, the power consumption of the earphone part can be substantially reduced. The actual telephone part may also become smaller, because it need not include a loudspeaker. The use of the telephone part becomes easier, because it need never be placed on the user's ear when speaking. According to the idea of the invention, the small telephone part can more easily be placed on the user's wrist like a watch, for example.

In addition to a telephone, a HF device can also be connected to function together with other devices producing or using sound or information, such as a radio, television or other audiovisual device. A HF device can also be utilized in information systems, from which messages are transmitted to the user, either as directed to one user only, or as a broadcast transmission to a number of users. If the HF device also includes a transmitter, it may also function as the person's identifier, in which case the HF device transmits its own series of numbers/characters to a receiving device in the vicinity. The telephone part may also function as the identifier in a corresponding manner. This information can also be used in monitoring the working hours or locating a person, even inside a building, where the GPS devices generally used outdoors are not capable of positioning.

The sound reproduction system can also be implemented by two HF devices placed in both ears, whereby it is possible to provide stereophonic sound to the user, or a different sound to each ear, even from different sources, when required. For example, a group phone call between three or more people sounds much more natural to the user when the voices of the persons are heard from different directions. In a device and method according to the invention, the importance of the display can also be reduced or even entirely removed, because all the conventional menus can be provided to the user's ear as sound menus, and the functions can be controlled by the position and/or movement of the device, for example. Then it is also possible to reduce the number of keys in the device. If the person's communication system requires functions in which a larger display or a writing keyboard is needed, they can be wirelessly connected to the telephone part and/or earphone part.

According to the invention, the method also enables establishing so-called internal calls between users at close distance, or alternatively it is possible to collect a number of users in their own cells at a place of work, for example, from which the calls are directed through a switching centre to wired external lines or common radio network lines. The costs of phone calls can thereby be reduced, because every employee does not need a globally operating telephone connection. In other words, the telephone parts can form a network, in which information can be transferred between different devices, and when required, it is possible to communicate outward from this network either directly from the phone parts or centrally through the inner network. Communication through the internal network reduces the power requirement of the telephone part, because then the radio communication requires substantially less power than otherwise. In the internal network, it also possible to influence the charging practice of the calls so that at the place of work, for example, the calls are automatically charged to the employer's account instead of the user's own subscription.

Because the earphone part is continuously ready for operation in the user's ear, conversations between two or more users can also be created easily. The users voice is digitalized in the equipment, and through the data transfer properties of the telephone part, the information is transferred to the parties of the conversation group and vice versa (e.g. with the GSM, PDC, PCS, GPRS, EDGE, 3G, WCDMA, CDMA, TDMA or UMTS and/or other corresponding techniques), and the information transferred is converted in the system of the equipment back into voice, which can be heard by the user/users. The method has the advantage that an actual, time-consuming phone call need not be made for starting a conversation, and the receiving party/parties need not answer the call, but the sound comes directly to the earphone part. An example of an application could be a conversation between an athlete and a coach during a sports performance. For example, in relay skiing, all the competitors of the team can hear the coach's instructions to the athlete in the middle of the performance, and other athletes of the same team (or others who have been placed in the same conversation group) can give further comments to be heard by everybody. The use of conversation connections makes it easier to hold negotiations between members of a working team, for example, regardless of where the members of the team are.

The telephone part according to the invention need not necessarily be a device resembling a watch, but it may resemble a conventional mobile phone. A preferred embodiment for the invention may also be one having a GPS and/or a bar code reader integrated in the telephone part. With those additions, the device is a versatile data collection device, which can be used for monitoring the working hours, for example, in which case the bar code provides a possibility to input to the device information on the person(s), tasks, steps of work, places where work is done, amounts, products, materials etc. By the GPS, the device is capable of positioning where GPS equipment generally function, and in other places the positioning can be arranged to function either by using bar codes or by arranging low-power radio transmitters (e.g. UWB), which transmit position information to the telephone part(s), in indoor locations. The device can be used in various applications for monitoring working hours, such as e.g. people working alone, security companies and people working in agriculture and forestry. The device can also be utilized in conventional places of work, because even very short tasks can be more easily registered by the device according to the invention, because the device is either personal and always carried along or otherwise close to the place where the work is performed. In addition, fixed installations of devices for monitoring working hours are often difficult and very costly.

The devices according to the invention need not be installed as fixed, and therefore they can also be easily moved to other points of work, when required. The device according to the invention enables registration of events regardless of the time and place. If the place does not have a functional GPRS network or other data transfer network, the registered information is transferred from the memory of the device later when the device is in the area of a data transfer network. By using GPS, the system can also create a driver's log by registering the routes driven and providing them with time information. The information of the movement/position sensor can be used in the device to alarm automatically, if the device stays in the same position for too long. Due to the communications of the telephone part, the system is nearly in real time in the system, which controls events (software functioning in a PC, for example), but the telephone parts can also collect information into their memory, and the information is then inputted to the system as batch processing when desired.

The objectives of the invention can be achieved by a method and equipment in which the radio receiver and the possible transmitter or a combination thereof is placed in the user's ear or its immediate vicinity. The device is provided with intelligent power switching electronics, by which the power consumption of the HF device is almost zero or it does not consume electric power at all in the standby state. Power consumption increases for the duration of the actual use, when a connection is established with the host device(s). In this method, the size of the telephone part can be made smaller than in the present phones, because its loudspeaker can be left out, as well as the display, if it is so desired. In the same way, the keyboard of the telephone part can be simplified to the minimum.

The telephone part may have acceleration sensor(s) or other corresponding sensor(s), which react(s) to the position and/or movement of the telephone part. This enables implementing in the host device menus, in which the selection is made by means of movement and/or position, and additionally by a keyboard, when required, and sound information is also formed of the selection to the user's earphone part. This sound information can be speech, signal sounds of different frequencies, music or other corresponding sound signal. Because the earphone part is already in the user's ear ready for the situation in which it will be used, the use of the device is natural. The method can be compared to the present mobile phone systems, for example, in which a large number of different functions are integrated in one functional device. In the method and device according to the invention, functions are split between several devices, and radio communication connections are established between them. Thus, for example, sending text messages takes place in the system more easily by using a separate typewriting keyboard/display, which communicates with the telephone part.

In the method and device arrangement, various devices which produce or use information can be connected with each other as part of a personal communication system. Devices like this include a camera, scanner, printer, telephone, microphone, loudspeaker, equipment for presenting or producing a video or other image, radio, projector, bar code reader, RFID reader, GPS receiver, personal computer or other corresponding device. Common to these devices is the fact that they process or produce information.

By one or more microphone and the electronics and the software of the device, the system can learn the frequency spectrum of its user's voice, by which it can control an equalizer and improve the quality of the output sound and reduce superfluous noise.

The HF device can be connected to a car radio, for example, so that different users of the car radio can listen to different channels without disturbing each other. In that case, this function has been taken into account in the manufacture of the car radio by providing the device by a number of conventional tuner parts or a modern, digital radio receiver. The telephone part may also directly function as the digital radio receiver.

By the software of the equipment it is possible, for example, to deliver a text message to the user's ear as speech, and correspondingly convert speech into a text message for transmission. Using MMS sound messages becomes more natural and user friendly with the equipment.

The present invention helps to solve the above mentioned problems and to eliminate the drawbacks of the prior art, and provides HF devices, which are more reliable and usable, can be used in a versatile manner in different situations and are substantially smaller than the prior art HF devices.

These advantages are achieved by a method, device arrangement, telephone part and earphone part, which are characterized in what is set forth in the independent claims.

Some preferred embodiments of the invention are presented in the dependent claims.

In the following, the invention will be described in more detail by means of some preferred embodiments and with reference to the accompanying drawings, in which

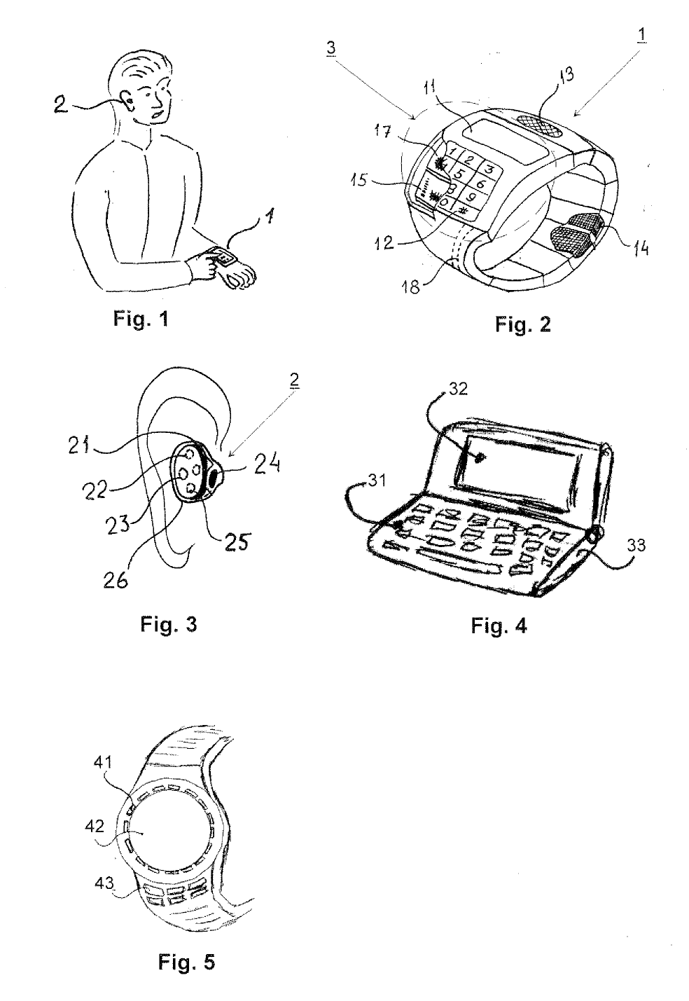

FIG. 1 shows an example of a device arrangement according to the invention, in which the earphone part is placed in the user's ear and the telephone part in his hand,

FIG. 2 shows the telephone part of the device arrangement of FIG. 1 by way of example,

FIG. 3 shows the earphone part of the device arrangement of FIG. 1 by way of example,

FIG. 4 shows a keyboard and display device used in connection with an embodiment of the invention, and

FIG. 5 shows another alternative embodiment for the telephone part shown in FIG. 2.

The device arrangement according to the invention is implemented by devices, which include an earphone part 2, a telephone part 1 and advantageously also a keyboard and display device 3.

There is a radio connection between the telephone part 1 and the earphone part 2. The radio connection is a low-power connection, because the devices are close to each other, and the radio communication is not wanted to reach other devices, which are further away. If a device not belonging to the system gets a radio transmission, it is not converted into sound or other information, if it is not intended to be a broadcast transmission. A suitable encryption technique is advantageously used in the radio communication in order to prevent unauthorized devices from opening transmissions not intended for them. The control electronics 23 of the earphone part 2 advantageously include information decryption and a power management system, which reduces the power consumption to zero or close to zero when there is no communication between the earphone part 2 and the telephone part 1. During radio communication, information is transferred as bursts on the radio path, and the radio part 22 is switched either to the standby mode or the sleep mode, which consumes less power, after the burst has ended.

When the earphone part gets a sound-information burst, it delivers the sound to the user's ear, extending the sound to its real length. For example, if information is transferred at intervals of 0.2 seconds, and 0.2 milliseconds are required for transferring the information, the average power requirement is then roughly 1/1000 of the power requirement of the actual moment of operation. The calculation is only preliminary, and factors contributing to the real, average power requirement include switching times, other power peaks, the amount of information and the cycle of data transfer. In theory, the speed of data transfer, when the UWB (Ultra Wide Band) technique, for example, is used, can be 480 Mbit/s at present, and so the average power requirement becomes significantly smaller than in the previous example with fast switching times. If the data transfer cycle of information is made less frequent, the average power requirement can be reduced, but the sound formed for the user is delayed, and it may feel like an uncomfortable delay during a telephone conversation.

The radio part 22 includes a receiver and advantageously also a transmitter. The earphone part 2 can be switched on to the actual operation either as timed, but at sufficiently long intervals in order to prevent the power consumption from rising too high. Another way of switching on takes place by a radio transmission of the telephone part or other device operating in the system. Thus the earphone part 2 also communicates with other devices using the same RF system, when required.

The earphone part 2 has been made so small that it can be fitted either entirely or partly into the user's ear or even the canal of the ear. In order to make sure that the device stays in the ear, it can also be provided with a bow placed behind the ear, for example.

The earphone part also includes a battery 21 and possibly a charging system 26, which can be implemented by solar cells, kinetic energy, sound energy, induction or by a thermoelectric converter. The rechargeable battery 21 of the earphone part may also be replaced by a small, non-rechargeable battery, in which case the charging system is not needed.

For external sounds intended to be heard from other sources, the earphone part 2 also has a sound channel 25, which lets the sounds into the ear, and at the same time functions as a pressure balancing path to the ear. In addition to the basic, standard device, the earphone part 2 can also be equipped with a personal, well shaped adapter, which ensures comfortable, long-time use of the device. The earphone part includes a loudspeaker 24 or other component for producing the sound.

The signal from the telephone 1 to the earphone 2 is simplex with regard to speech, and therefore the power requirement in the earphone is very small. Duplex communications are only required if the telephone has so-called higher level functions, such as handshaking between the telephone part 1 and the earphone part 2, or corresponding functions. From the telephone part 1, it is possible to transfer to the earphone part 2 and vice versa also other information than speech and sound, such as information on the energy level or voltage of the rechargeable or non-rechargeable battery. The other information can be used for adjusting the sound volume of the earphone part and/or the equalization of the sound. The telephone part or other device connected to the system can measure the volume level of the surrounding sound by a microphone/microphones and optimize the volume of the sound coming to the ear automatically to adapt to the surrounding noise.

If a microphone (not shown) is also directly connected to the earphone part 2, the surrounding noise can be attenuated by it simply by producing a sound having the opposite phase in the loudspeaker part (24) of the earphone part. The attenuation can be switched on and off by the telephone part, or its power can be adjusted. Sound attenuation implemented like this can be utilized when working in a noisy environment, or to eliminate the disturbing sound caused by a snoring partner at night, for example. Instead of attenuation, the sound can also be amplified by a microphone and controlled by the telephone part 1. The operation is controlled by the control electronics 23 of the earphone part. The sound energy produced by the microphone can also be converted into electricity, stored into a capacitor/capacitors or a battery/batteries and be used during actual operation.

For example, when used in a car, the telephone part 1 can adjust the sound of the car radio functioning as a part of the device arrangement to a lower volume, when a call is becoming connected or has already become connected.

The telephone part 1 consists of a display 11, keyboard 12, one or more microphones 13, battery 14, radio unit 15, electronic unit 17 and antenna unit 18. The radio technique used can be, for example, the UWB technique, which has a high data transfer capacity with a low power requirement. With UWB, duplex transmission is also easily implemented without significantly increasing the power consumption. The telephone itself need not have an earphone part at all, and it can therefore be made smaller. The space freed from this can be used for other requirements, such as a display or a keypad. Because the earphone part 2 is separate from the telephone part 1, the actual telephone part can be advantageously shaped ergonomically to fit on a wrist, for example. For saving space and for maximizing the battery capacity, the battery 14 of the telephone part can also be placed in a wristband.

In order to enable the use of several phones and earphones in the same area, the radio communication between the telephone part 1 and the earphone part 2 can be synchronized. The synchronization takes place in such a way, for example, that the telephone parts hear the transmissions of other telephones in the vicinity. The communication is divided by time, and the new starting calls are connected to the time division in free time-slots. Instead of synchronization, it is also possible to utilize generally known collision protocols. The UWB band or other radio-technical band is also divided between speech, handshaking and other factors controlling the system. The communications can also function with generally known data transfer protocols, such as the TCP, UDP or IP protocols.

Each device has its own unique address identifier in the system, by which the system verifies the devices when they function as independent devices of the network. It is thus possible to create controlled information traffic between the parts of the system.

The microphone part in the telephone part may consist of one or more microphones. The use of more than one microphones makes it possible to compensate out background noise and to amplify the user's speech or some other sound signal. Then e.g. the direction of the sound can be identified, and sound coming from other directions can be attenuated, when required. If the device has many microphones, they can be advantageously located on different sides of the telephone part 1 in order to better recognize the direction from which the sound is coming. The microphone can be integrated into the telephone or the earphone, or it can form the same type of small component as the earphone to be placed in the ear. This can again be freely located in a place chosen by the user, e.g. on the collar of a working shirt as a part of the piece of clothing, or to other clothing accessories in the operating environment of the device.

It is also possible to connect to the telephone part 1 or the earphone part 2 with other devices using the same radio technique. FIG. 4 shows a device with a larger keyboard 31 and display 32. The electronic unit of the device includes the required RF-technical components, such as the UWB components and the software supporting the function. This device can be a palm computer or other corresponding device.

FIG. 5 shows an alternative embodiment for the telephone part 1, in which the size of the display 42 can be increased substantially by placing the keys 41 around it. The display 42 can also be of some other shape than round. The body of the telephone part can be provided with additional keys 43, when required. For other parts, the telephone part is in accordance with the telephone part 1 described earlier.

Because it is difficult to place a large, easy-to-use keyboard in a small device, an advantageous solution is to implement a touch-sensitive plate in the device. The touch-sensitive plate can be located either on top of the display, or alternatively in some other place of the device. The user of the device can write or draw on the touch-sensitive display, and the device interprets the drawn characters as letters, numbers or other symbols, by which the operation of the device can be controlled. If the touch-sensitive plate is not large, the user must write and input the characters consecutively on the same spot on the plate on top of each other.

Normally, writing on paper or some other material takes place by putting the letters and characters from left to right, from right to left, from up to down or from down to up. In this device arrangement according to the invention, the letters or characters are inputted on top of each other at the same point of the touch-sensitive plate, and the device interprets the characters one by one. In the device arrangement according to the invention, it is also possible to draw on the touch-sensitive plate regardless of the position of the device, i.e. the position of the touch-sensitive plate. The device interprets the drawing regardless of the direction of the drawing. This facilitates the use of the device, because it can be located on the user's wrist, for example, when the hand is in different positions.

The display of the device can show the result visually, as a clear combination of characters/numbers or words and a combination thereof. In addition to this, the system enables giving feedback to the user in the form of sound, by forming audio signals of the inputted characters to the user's earphone part. When driving a car, for example, the invention enables a safer way of using the phone, when it is not necessary to follow the display of the device.

The device arrangement can also be provided with a corresponding touch-sensitive plate in such a way that it is not physically located in the same device, but is connected to the device arrangement through a RF interface.

The drawings and the related explanation are intended to illustrate the present invention by way of example only. In its details, the invention can vary within the inventive idea presented in the accompanying claims and the description of the invention. It is clear to a person skilled in the art that the dimensions of the devices and the detailed solutions can vary depending on the application. It is also obvious to a person skilled in the art that the embodiments of the invention can vary within the scope of the conditions of use, customer requirements, serial working methods and the manufacturing solutions chosen in connection with mass production.

1-31. (canceled)

32. A method for producing sound wirelessly to the user's ear, in which method a low-power radio network is utilized at least between a first electronic device, which is a terminal device (1) of a cellular network and one or more earphone parts (2) placed in the user's ear and producing the sound to the ear, in which radio network said devices operate independently, using the same data transfer technique, characterized in that the data communication in the method is essentially simplex from the first electronic device (1) to the earphone part(s) (2), and the earphone part/parts (2) do not transmit the user's speech to the first electronic device (1), but the user's voice or other possible sound is transmitted directly by means of sound waves to the first electronic device (1).

33. The method according to claim 32, characterized in that at least one of the following is used in data transfer between the first device (1) and the earphone part (2) in the radio network: the UWB technique, low-power RF technique, TCP, UDP or IF protocol.

34. The method according to claim 32, characterized in that the earphone part (2) is a small-sized earphone, which fits the user's ear or canal of the ear, and has such a low average power consumption that it remains ready for use in the ear or the canal of the ear for a long time.

35. The method according to claim 32, characterized in that the radio communications between the telephone part (1) and the earphone part (2) is controlled:
by unique address identifiers
by time division, and/or
in accordance with a collision protocol.

36. The method according to claim 32, characterized in that the information in the radio communications between the devices is encrypted.

37. The method according to claim 32, characterized in that the power consumption of the devices of the system, especially the earphone part (2), is reduced or the device is switched off when there is no radio communication between the devices.

38. The method according to claim 37, characterized in that the power consumption of the system is reduced by transmitting information as bursts, in which case the power consumption required by radio communications between the burst is low or zero.

39. The method according to claim 32, characterized in that the cellular network technique is one of the following: GSM, PDC, PCS, GPRS, EDGE, 3G, WCDMA, CDMA, TDMA or UMTS.

40. The method according to claim 32, characterized in that in addition to sound, information on the charge status of the power source is transferred between said devices, and/or the sound volume is controlled and/or other functions in the devices are controlled, and/or user information is transferred.

41. The method according to claim 32, characterized in that the telephone part (1) is controlled by menus, in which the selections are made at least partly on the basis of the movement(s) and/or position(s) of the device(s), and sound information is also formed of the selection to the user's earphone part.

42. A device arrangement for producing sound to the ear using a communication system based on a radio network, which device arrangement comprises at least a first electronic device (1), which is a terminal device of a cellular network, and at least one earphone part (2), characterized in that
the earphone part (2) can be fitted at least partly to the user's ear or the canal of the ear
the first electronic device has been arranged as separate from the earphone part (2), and that
the communication is essentially simplex from the first electronic device (1) to the earphone part(s) (2), and the earphone part(s) (2) do not transmit the user's speech to the first electronic device (1), but the user's voice or other possible sound is transmitted directly by sound waves to the first electronic device (1).

43. The device arrangement according to claim 42, characterized in that the first electronic device is the telephone part (1) of a mobile phone, which is arranged as essentially separate from the earphone part (2), in connection with a wrist, for example.

44. The device arrangement according to claim 42, characterized in that one or more microphones (13) have also been arranged to be used in the device arrangement.

45. The device arrangement according to claim 44, characterized in that the microphone part (13) has been integrated either into the first electronic device (1) and/or has been placed freely in a suitable place in the operation environment, such as in connection with clothing accessories.

46. The device arrangement according to claim 45, characterized in that the microphone part (13) comprises at least one microphone, which has been arranged, together with the software or electronics of the device, to carry out at least one of the following measures:
to attenuate unwanted sounds
to adjust the equalizer in the device, whereby selected frequencies can be amplified, and other selected frequencies can be attenuated
to recognize the user's voice from its frequency spectrum
to adjust the volume of the sound coming to the earphone part (2) automatically to the correct level
to produce the sound wanted by the user to the system to be transmitted by the telephone part to at least one other party.

47. The device arrangement according to claim 44, characterized in that the device arrangement comprises two or more microphones:
for determining the direction from which the sound is coming, and/or
for amplifying and/or attenuating the user's speech.

48. The device arrangement according to claim 44, characterized in that the sound energy produced by the microphone or other component transforming sound to electricity has been arranged to be converted to electric energy, which has been arranged to be utilized in the operation of the device arrangement.

49. A handsfree earphone part (2) for producing sound to the ear, which earphone part (2) has been arranged to communicate via a radio network with a first device (1) using the same communication protocol, and that the earphone part (2) has its own communication identifier in the radio network, characterized in that the communication is essentially simplex from the first device (1) to the earphone part (2), and that the earphone part (2) does not transmit the user's speech to the first electronic device (1), but the first electronic device (1) has been arranged to receive the user's voice or other possible as sound waves.

50. The earphone part according to claim 49, characterized in that the earphone part (2) has been arranged to communicate via the radio network with the telephone part (1) of the terminal device of the cellular network.

51. The earphone part according to claim 49, characterized in that the two earphone parts (2) in both ears have been arranged to provide stereophonic reproduction.

52. The earphone part according to claim 49, characterized in that there is a microphone/microphones (13) in the earphone part(s) (2), the sound recognized by which is arranged to produce a sound signal of the opposite phase to the user's ear to attenuate an unwanted sound sensed by the user.

53. The earphone part according to claim 49, characterized in that the earphone part (2) has a sound channel, which has been arranged to let external sounds to the user's ear and/or to function for balancing pressure in the ear.

54. The earphone part according to claim 49, characterized in that a charging system of the power source of the earphone part has been arranged to function in at least one of the following ways: solar cell, kinetic energy, sound energy, induction, thermoelectric converter or an external charging device.

55. A telephone part (1) of a terminal device of a cellular network, comprising means for connecting to a cellular network and at least one microphone, which telephone part (1) also comprises means for exchanging information via a radio network with at least one earphone part (2), which can be fitted to the user's ear for producing sound, characterized in that the communication between the telephone part (1) and the earphone part (2) is essentially simplex from the first electronic device (1) to the earphone part/parts (2), and that the earphone part(s) (2) do not transmit the user's speech to the first electronic device (1), but the user's voice or other possible sound is transmitted directly by sound waves to the first electronic device (1).

56. The telephone part according to claim 55, characterized in that the telephone part (1) resembles a watch, and/or its keyboard has been arranged around a display.

57. The telephone part according to claim 55, characterized in that the telephone part (1) has a sensor, which reacts to the position and/or motion of the telephone part, in which case the message of the sensor can be used for implementing menus and/or for producing sound to the earphone part (2) in the user's ear.

58. The telephone part according to claim 57, characterized in that said sensor is an acceleration sensor.

59. The telephone part according to claim 55, characterized in that the wristband belonging to the telephone part (1) also comprises a battery/batteries.

60. The telephone part according to claim 55, characterized in that it comprises at least two microphones (13).

61. The telephone part according to claim 60, characterized in that the sound recognized by the microphone (13) has been arranged to be sent to the telephone part for controlling its operation.

62. The telephone part according to claim 55, where the keypad has been replaced by a touch-sensitive surface, where a character drawn/written on it has been arranged to be converted to keystrokes and characters, which have been arranged to be presented on the display of the device, characterized in that the telephone part (1) has been arranged to transmit a sound feedback thereof as speech and sound symbols wirelessly to the earphone part (2).
